(19) United States
(12) Patent Application Publication
(10) Pub. No.: US 2015/0199965 A1
(43) Pub. Date: Jul. 16, 2015

(54) SYSTEM AND METHOD FOR RECOGNITION AND AUTOMATIC CORRECTION OF VOICE COMMANDS

(71) Applicant: CloudCar Inc., Los Altos, CA (US)

(72) Inventors: Bruce Leak, Los Altos Hills, CA (US); Zarko Draganic, Belvedere, CA (US)

(73) Assignee: CloudCar Inc., Los Altos, CA (US)

(21) Appl. No.: 14/156,543

(22) Filed: Jan. 16, 2014

(51) Int. Cl. G10L 15/22

(52) U.S. Cl. CPC G10L 15/22

(57) ABSTRACT

A system and method for recognition and automatic correction of voice commands are disclosed. A particular embodiment includes: receiving a set of utterance data, the set of utterance data corresponding to a voice command spoken by a speaker; performing a first-level speech recognition analysis on the set of utterance data to produce a first result, the first-level speech recognition analysis including generating a confidence value associated with the first result, the first-level speech recognition analysis also including determining if the set of utterance data is a repeat utterance corresponding to a previously received set of utterance data; performing a second-level speech recognition analysis on the set of utterance data to produce a second result, if the confidence value associated with the first result does not meet or exceed a pre-configured threshold or if the set of utterance data is a repeat utterance; and matching the set of utterance data to a voice command and returning information indicative of the matching voice command without returning information that is the same as previously returned information if the set of utterance data is a repeat utterance.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2014, CloudCar Inc., All Rights Reserved.

### TECHNICAL FIELD

This patent document pertains generally to tools (systems, apparatuses, methodologies, computer program products etc.) for allowing electronic devices to share information with each other, and more particularly, but not by way of limitation, to a system and method for recognition and automatic correction of voice commands.

### BACKGROUND

An increasing number of vehicles are being equipped with one or more independent computer and electronic processing systems. Certain of the processing systems are provided for vehicle operation or efficiency. For example, many vehicles are now equipped with computer systems or other vehicle subsystems for controlling engine parameters, brake systems, tire pressure and other vehicle operating characteristics. Additionally, other subsystems may be provided for vehicle driver or passenger comfort and/or convenience. For example, vehicles commonly include navigation and global positioning systems and services, which provide travel directions and emergency roadside assistance, often as audible instructions. Vehicles are also provided with multimedia entertainment systems that may include sound systems, e.g., satellite radio receivers, AM/FM broadcast radio receivers, compact disk (CD) players, MP3 players, video players, smartphone interfaces, and the like. These electronic in-vehicle infotainment (IVI) systems can also provide navigation, information, and entertainment to the occupants of a vehicle. The IVI systems can source navigation content, information, and entertainment content from a variety of sources, both local (e.g., within proximity of the IVI system) and remote (e.g., accessible via a data network).

Functional devices, such as navigation and global positioning receivers (GPS), wireless phones, media players, and the like, are often configured by manufacturers to produce audible instructions or information advisories for users in the form of audio streams that audibly inform and instruct a user. Increasingly, these devices are also being equipped with voice interlaces, so users can interact with the devices in a hands-free manner using voice commands. However, in an environment such as a moving vehicle, ambient noise levels can interfere with the ability of these voice interfaces to properly and efficiently receive and process voice commands from a user. As a result, voice commands can be misunderstood by the device, which can cause incorrect operation, incorrect guidance, and user frustration with devices that use such standard voice interfaces.

### BRIEF DESCRIPTION OF THE DRAWINGS

The various embodiments are illustrated by way of example, and not by way of limitation, in the figures of the accompanying drawings in which:

FIG. 1 illustrates a block diagram of an example ecosystem in which an in-vehicle infotainment system and a voice command recognition and auto-correction module of an example embodiment can be implemented;

FIG. 2 illustrates the components of the voice command recognition and auto-correction module of an example embodiment;

FIGS. 3 and 4 are processing flow diagrams illustrating an example embodiment of a system and method for recognition and automatic correction of voice commands; and

FIG. 5 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

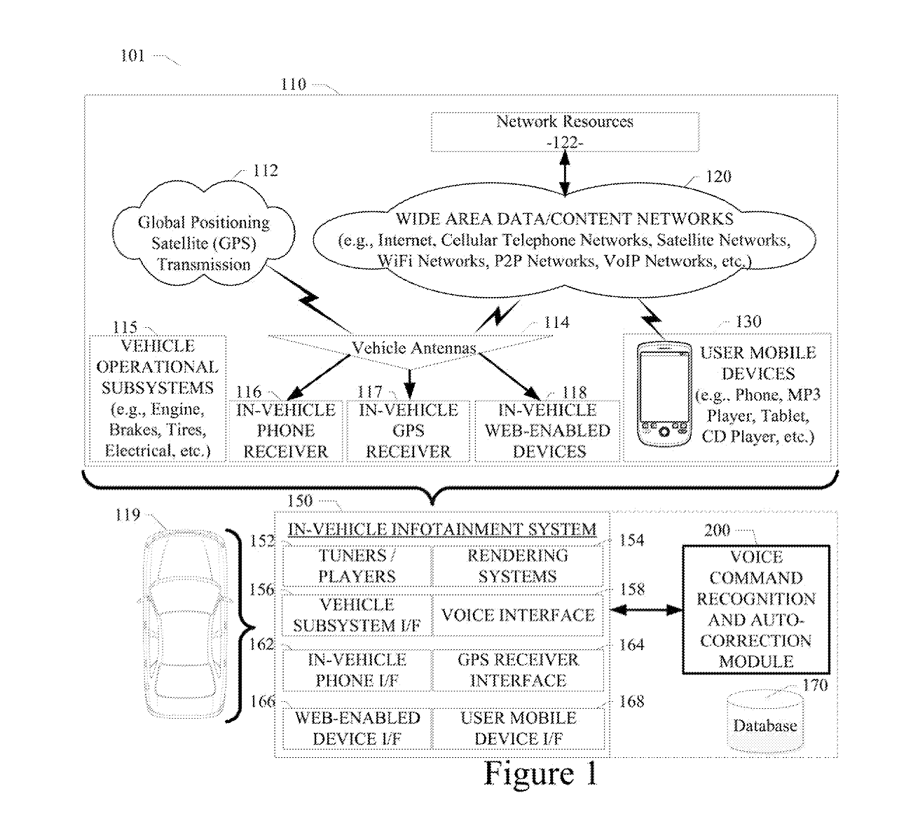

As described in various example embodiments, a system and method for recognition and automatic correction of voice commands are described herein. In one example embodiment, an in-vehicle infotainment system with a voice command recognition and auto-correction module can be configured like the architecture illustrated in FIG. 1. However, it will be apparent to those of ordinary skill in the art that the voice command recognition and auto-correction module described and claimed herein can be implemented, configured, and used in a variety of other applications and systems as well.

Referring now to FIG. 1, a block diagram illustrates an example ecosystem 101 in which an in-vehicle infotainment (IVI) system 150 and a voice command recognition and auto-correction module 200 of an example embodiment can be implemented. These components are described in more detail below. Ecosystem 101 includes a variety of systems and components that can generate and/or deliver one or more sources of information/data and related services to the IVI system 150 and the voice command recognition and auto-correction module 200, which can be installed in a vehicle 119. For example, a standard Global Positioning Satellite (GPS) network 112 can generate position and timing data or other navigation information that can be received by an in-vehicle GPS receiver 117 via vehicle antenna 114. The IVI system 150 and the voice command recognition and auto-correction module 200 can receive this navigation information via the GPS receiver interface 164, which can be used to connect the IVI system 150 with the in-vehicle GPS receiver 117 to obtain the navigation information.

Similarly, ecosystem 101 can include a wide area data/content network 120. The network 120 represents one or more conventional wide area data/content networks, such as a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, call distribution sites, headend sites, or the like. The network resources 122 can generate and/or distribute data, which can be received in vehicle 119 via one or more antennas 114. Antennas 114 can serve to connect the IVI system 150 and the voice command recognition and auto-correction module 200 with the data/content network 120 via cellular, satellite, radio, or other conventional signal reception mechanisms. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice over IP (VoIP) networks, and the like are also well-known. Thus, as described in more detail below, the IVI system 150 and the voice command recognition and auto-correction module 200 can receive telephone calls and/or phone-based data transmissions via an in-vehicle phone interface 162, which can be used to connect with the in-vehicle phone receiver 116 and network 120. The IVI system 150 and the voice command recognition and auto-correction module 200 can receive web-based data or content via an in-vehicle web-enabled device interface 166, which can be used to connect with the in-vehicle web-enabled device receiver 118 and network 120. In this manner, the IVI system 150 and the voice command recognition and auto-correction module 200 can support a variety of network-connectable in-vehicle devices and systems from within a vehicle 119.

As shown in FIG. 1, the IVI system 150 and the voice command recognition and auto-correction module 200 can also receive data and content from user mobile devices 130. The user mobile devices 130 can represent standard mobile devices, such as cellular phones, smartphones, personal digital assistants (PDA's), MP3 players, tablet computing devices (e.g., iPad), laptop computers, CD players, and other mobile devices, which can produce and/or deliver data and content for the IVI system 150 and the voice command recognition and auto-correction module 200. As shown in FIG. 1, the mobile devices 130 can also be in data communication with the network cloud 120. The mobile devices 130 can source data and content from internal memory components of the mobile devices 130 themselves or from network resources 122 via network 120. In either case, the IVI system 150 and the voice command recognition and auto-correction module 200 can receive this data and content from the user mobile devices 130 as shown in FIG. 1.

In various embodiments, the mobile device 130 interface and user interface between the IVI system 150 and the mobile devices 130 can be implemented in a variety of ways. For example, in one embodiment, the mobile device 130 interface between the IVI system 150 and the mobile devices 130 can be implemented using a Universal Serial Bus (USB) interface and associated connector.

In another embodiment, the interface between the IVI system 150 and the mobile devices 130 can be implemented using a wireless protocol, such as WiFi or Bluetooth® (BT). WiFi is a popular wireless technology allowing an electronic device to exchange data wirelessly over computer network. Bluetooth® is a wireless technology standard for exchanging data over short distances.

Referring again to FIG. 1 in an example embodiment as described above, the in-vehicle infotainment system 150 and the voice command recognition and auto-correction module 200 can receive navigation data, information, entertainment content, and/or other types of data and content from a variety of sources in ecosystem 101, both local (e.g., within proximity of the IVI system 150) and remote (e.g., accessible via data network 120). These sources can include wireless broadcasts, data and content from proximate user mobile devices 130 (e.g., a mobile device proximately located in or near a vehicle), data and content from network 120 cloud-based resources 122, an in-vehicle phone receiver 116, an in-vehicle GPS receiver or navigation system 117, in-vehicle web-enabled devices 118, or other in-vehicle devices that produce or distribute data and/or content.

Referring still to FIG. 1, the example embodiment of ecosystem 101 can include vehicle operational subsystems 115. For embodiments that are implemented in a vehicle 119, many standard vehicles include operational subsystems, such as electronic control units (ECUs) supporting monitoring/control subsystems for the engine, brakes, transmission, electrical system, emissions system, interior environment, and the like. For example, data signals communicated from the vehicle operational subsystems 115 (e.g., ECUs of the vehicle 119) to the IVI system 150 via vehicle subsystem interface 156 may include information about the state of one or more of the components of the vehicle 119. In particular, the data signals, which can be communicated from the vehicle operational subsystems 115 to a Controller Area Network (CAN) bus of the vehicle 119, can be received and processed by the IVI system 150 and the voice command recognition and auto-correction module 200 via vehicle subsystem interface 156. Embodiments of the systems and methods described herein can be used with substantially any mechanized system that uses a CAN bus as defined herein, including, but not limited to, industrial equipment, boats, trucks, or automobiles; thus, the term “vehicle” extends to any such mechanized systems. Embodiments of the systems and methods described herein can also be used with any systems employing some form of network data communications; however, such network communications are not required.

In the example embodiment shown in FIG. 1, the IVI system 150 represents a vehicle-resident control and information monitoring system as well as a multimedia entertainment system. In an example embodiment, the IVI system 150 can include sound systems, satellite radio receivers, AM/FM broadcast radio receivers, compact disk (CD) players, MP3 players, video players, smartphone interfaces, wireless computing interfaces, navigation/GPS system interfaces, and the like. As shown in FIG. 1, such IVI systems 150 can include a tuner, modem, and/or player module 152 for selecting content received in content streams from the local and remote content sources described above. The IVI system 150 can also include a rendering system 154 to enable a user to view and/or hear information, content, and control prompts provided by the IVI system 150. The rendering system 154 can include visual display devices (e.g., plasma displays, liquid crystal displays (LCDs), touchscreen displays, or the like) and speakers, audio output jacks, or other audio output devices.

In the example embodiment shown in FIG. 1, the IVI system 150 can also include a voice interface 158 for receiving voice commands and voice input from a user/speaker, such as a driver or occupant of vehicle 119. The voice interface 158 can include one or more microphones or other audio input device(s) positioned in the vehicle 119 to pick up speech utterances from the vehicle 119 occupants. The voice interface 158 can also include signal processing or filtering components to isolate the speech or utterance data from background noise. The filtered speech or utterance data can include a plurality of sets of utterance data, wherein each set of utterance data represents a single voice command or a single statement or utterance spoken by a user/speaker. For example, a user might issue the voice command, “Navigate to 160 Maple Avenue.” This voice command is processed by an example embodiment as a single voice command with a corresponding set of utterance data. A subsequent voice command or utterance by the user is processed as a different set of utterance data. In this manner, the example embodiment can distinguish between utterances and produce a set of utterance data for each voice command or single statement spoken by the user/speaker. The sets of utterance data can be obtained by the voice command recognition and auto-correction module 200 via the voice interface 158. The processing performed on the sets of utterance data by the voice command recognition and auto-correction modulo 200 is described in more detail below.

Additionally, ether data and/or content (denoted herein as ancillary data) can be obtained from local and/or remote sources as described above. The ancillary data can be used to augment or modify the operation of the voice command recognition and auto-correction module 200 based on a variety of factors including, the identity and profile of the speaker, the context in which the utterance is spoken (e.g., the location of the vehicle, the specified destination, the time of day, the status of the vehicle, the relationship between the current utterance and a prior utterance, etc.), the context of the speaker (e.g., whether travelling for business or pleasure, whether there are events in the speaker's calendar or correspondence in their email or message queues, the status of processing of the speaker's previous utterances on other occasions, the status of processing of other speaker's related utterances, the historical behavior of the speaker while processing the speaker's utterances, and a variety of other data obtainable from a variety of sources, local and remote.

In a particular embodiment, the IVI system 150 and the voice command recognition and auto-correction module 200 can be implemented as in-vehicle components of vehicle 119. In various example embodiments, the IVI system 150 and the voice command recognition and auto-correction module 200 can be implemented as integrated components or as separate components. In an example embodiment, the software components of the IVI system 150 and/or the voice command recognition and auto-correction module 200 can be dynamically upgraded, modified, and/or augmented by use of the data connection with the mobile devices 130 and/or the network resources 122 via network 120. The IVI system 150 can periodically query a mobile device 130 or a network resource 122 for updates or updates can be pushed to the IVI system 150.

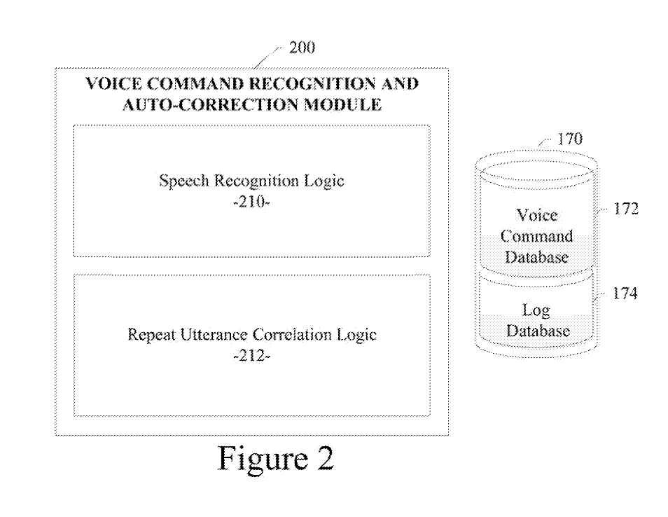

Referring now to FIG. 2, the diagram illustrates the components of the voice command recognition and auto-correction module 200 of an example embodiment. In the example embodiment, the voice command recognition and auto-correction module 200 can be configured to include an interface with the IVI system 150, as shown in FIG. 1, through which the voice command recognition and auto-correction module 200 can receive sets of utterance data via voice interface 158 as described above. Additionally, the voice command recognition and auto-correction module 200 can be configured to include an interface with the IVI system 150 and/or other ecosystem 101 subsystems through which the voice command recognition and auto-correction module 200 can receive ancillary data from the various data and content sources as described above.

In an example embodiment as shown in FIG. 2, the voice command recognition and auto-correction module 200 can be configured to include a speech recognition logic module 210 and a repeat utterance correlation logic module 212. Each of these modules can be implemented as software, firmware, or other logic components executing or activated within an executable environment of the voice command recognition and auto-correction module 200 operating within or in data communication with the IVI system 150. Each of these modules of an example embodiment is described in more detail below in connection with the figures provided herein.

The speech recognition logic module 210 of an example embodiment is responsible for performing speech or text recognition in a first-level speech recognition analysis on a received set of utterance data. As described above, the voice command recognition and auto-correction module 200 can receive a plurality of sets of utterance data from the IVI system 150 via voice interface 158. The sets of utterance data each represent a voice command, statement, or utterance spoken by a user/speaker. In a particular embodiment, the sets of utterance data correspond to a voice command or other utterance spoken by a speaker in the vehicle 119. The speech recognition logic module 210 can search database 170 and attempt to match the received set of utterance data to any of a plurality of sample voice commands stored in voice command database 172 of database 170. The sample voice commands stored in database 170 can include a typical or acceptable audio signature corresponding to a particular valid system command with an associated command code or command identifier. In this manner, the data stored in database 170 forms an association between a spoken audio signal or signature and a corresponding valid system voice command. Thus, a particular received utterance can be associated with a corresponding valid system voice command. However, it is unlikely that an utterance spoken by a particular speaker will exactly match a sample voice command stored in database 170. In most cases, a received utterance can be considered to match a sample voice command stored in database 170 if the received utterance includes a sufficient number of characteristics or indicia that match the sample voice command. The number of matching characteristics needed to be sufficient for a match can be pre-determined and pre-configured. Depending on the quality and nature of the received utterance, there may be more than one sample voice command in database 170 that matches the received utterance. As such, a plurality of sample voice command search results may be returned for a database 170 search performed for a given input utterance. However, the speech recognition logic module 210 can rank these search results based on the number of characteristics from the utterance that match a particular sample voice command. In other words, the speech recognition logic module 210 can use the matching characteristics of the utterance to generate to confidence value corresponding to the likelihood that (or the degree to which) a particular received utterance matches a corresponding sample voice command. The speech recognition logic module 210 can rank the search results based on the confidence value for a particular received utterance and to corresponding sample voice command. The sample voice command corresponding to the highest confidence value can be returned as the most likely voice command corresponding to the received utterance, if the highest confidence value meets or exceeds a pre-configured threshold value that defines whether a match is acceptable. If the received utterance does not match a sufficient number of characteristics from any sample voice command, the speech recognition logic module 240 can return a value indicating that no match was found. In either case, the speech recognition logic module 210 can produce a first result and a confidence value associated with the first result.

The content of the database 170 can be dynamically updated or modified at any time from local or remote (networked) sources. For example, a user mobile device 130 can be configured to store to plurality of spoken audio signatures and corresponding system voice commands. When a user brings his/her mobile device 130 into proximity with the IVI system 150 and the voice command recognition and auto-correction module 200, the mobile device 130 can automatically pair with the IVI system 150 and the content of the mobile device 130 can be synchronized with the content of database 170. The content of the database 170 can thereby get automatically updated with the plurality of spoken audio signatures and corresponding system voice commands from the user's mobile device 170. In this manner, the content of database 170 can be automatically customized for a particular user. This customization increases the likelihood that the particular user's utterances will be matched to a voice command in database 170 and thus the user's voice commands will be more often and more quickly recognized. Similarly, a plurality of spoken audio signatures and corresponding system voice commands customized for a particular user can be downloaded to the IVI system 150 from network resources 122 via network 120. As a result, new features can be easily added to the IVI system 150 and/or the voice command recognition and auto-correction module 200 or existing features can be easily and quickly modified or replaced. Therefore the IVI system 150 and/or the voice command recognition and auto-correction module 200 are highly customizable and adaptable.

As described above, the speech recognition logic module 210 of an example embodiment can attempt to match a received set of utterance data with a corresponding voice command in database 170 to produce a first result. If a matching voice command is found and the confidence value associated with the match is high (and meets or exceeds the pre-configured threshold), the high-confidence matching result can be returned and the processing performed by the voice command recognition and auto-correction module 200 can be terminated. However, in many circumstances, the speech recognition logic module 210 may not be able to match the received utterance with a corresponding voice command or the matches found may have low associated confidence values. This situation can occur if the quality of the received set of utterance data is low. Low quality utterance data can occur if the audio sample corresponding to the utterance is taken in an environment with high volume ambient noise, poor microphone positioning relative to the speaker, ambient noise with signal frequencies similar to the speaker's vocal tone, a speaker moving while speaking, and the like. Such situations can occur frequently in a vehicle where utterances compete with other interference in the environment. The voice command recognition and auto-correction module 200 is configured to handle voice recognition and auto-correction in this challenging environment. In particular, the voice command recognition and auto-correction module 200 includes a repeat utterance correlation logic module 212 to further process a received set of utterance data in a second-level speech recognition analysis when the speech recognition logic module 210 in the first-level speech recognition analysis may not be able to match the received utterance with a corresponding voice command or the matches found may have low associated confidence values (e.g., when the speech recognition logic module 210 produces poor results).

In the example embodiment shown in FIG. 2, the voice command recognition and auto-correction module 200 can be configured to include a repeat utterance correlation logic module 212. As described above, repeat utterance correlation logic module 212 of an example embodiment can be activated or executed in a second-level speech recognition analysis when the speech recognition logic module 210 produces poor results in the first-level speech recognition analysis. In a particular embodiment, the second-level speech recognition analysis performed on the set of utterance data is activated or executed to produce a second result, if the confidence value associated with the first result does not meet or exceed the pre-configured threshold. In many existing voice recognition systems, the traditional approach is to merely take another sample of the utterance from the speaker and to attempt recognition of the utterance again using the same voice recognition process. Unfortunately, this method can be frustrating for users when they are repeatedly asked to repeat an utterance.

The example embodiments described herein use a different approach. In the example embodiment implemented as repeat utterance correlation logic module 212, a more rigorous attempt is made in a second-level speech recognition analysis to filter noise and perform a deeper level of voice recognition analysis and/or a different voice recognition process on the set of utterance data when the speech recognition logic module 210 initially fails to produce satisfactory results in the first-level speech recognition analysis. In other words, subsequent or repeat utterances can be processed differently relative to processing performed on an original utterance. As a result, the second-level speech recognition analysis can produce a result that is not merely the same result produced by the first-level speech recognition analysis or previous attempts at speech recognition. Thus, the results produced for a repeat utterance are not the same as the results produced for a previous or original utterance. This approach prevents the undesirable effect produced when a system repeatedly generates an incorrect response to a repeated utterance. The different processing performed on the subsequent or repeat utterance can also be customized or adapted based on a comparison of the characteristics of the original utterance and the characteristics of the subsequent or repeat utterance. For example, the tone and pace of the original utterance can be compared with the tone and pace of the repeat utterance. The tone of the utterance represents the volume and the pitch or signal frequency signature of the utterance. The pace of the utterance represents the speed at which the utterance is spoken or the audio signature of the utterance relative to a temporal component. Changes in the tone or pace of the subsequent or repeat utterance relative to the original utterance can be used to re-scale the audio signature of the repeat utterance to correspond to the scale of the original utterance. The re-scaled repeat utterance in combination with the audio signature of the original utterance is more likely to be matched to a voice command in the database 170. Changes in the tone or pace of the repeat utterance can also be used as an indication of an agitated speaker. Upon detection of an agitated speaker, the repeat utterance correlation logic module 212 can be configured to offer the speaker an alternative command selection method rather than merely prompting again for another repeated utterance.

In various example embodiments, the repeat utterance correlation logic module 212 can be configured to perform any of a variety of options for processing a set of utterance data for which a high-confidence matching result could not be found by the speech recognition logic module 210. In one embodiment, the repeat utterance correlation logic module 212 can be configured to present the top several matching results with the highest corresponding confidence values. For example, the speech recognition logic module 210 may have found one or more matching voice command options, none of which had confidence values that met or exceeded a pre-determined high-confidence threshold (e.g., low-confidence matching results). In this case, the repeat utterance correlation logic module 212 can be configured to present the low-confidence matching results to the user via an audio or visual interface for selection. The repeat utterance correlation logic module 212 can be configured to limit the number of low-confidence matching results presented to the user to a pre-determined maximum number of options. In this situation, the user can be prompted to explicitly select a voice command option from the presented list of options to rectify the ambiguous results produced by the speech recognition logic module 210.

In another example embodiment, the repeat utterance correlation logic module 212 can be configured to more rigorously process the utterance for which either no matching results were found or only low-confidence matching results were found (e.g., no high-confidence matching result was found). In this example, the repeat utterance correlation logic module 212 can submit the received set of utterance data to each of a plurality of utterance processing modules to analyze the utterance data from a plurality of perspectives. The results from each of the plurality of utterance processing modules can be compared or aggregated to produce a combined result. For example, one of the plurality of utterance processing modules can be a signal frequency analysis module that focuses on comparing the signal frequency signatures of the received set of utterance data with corresponding signal frequency signatures of sample voice commands stored in database 170. A second one of the plurality of utterance processing modules can be configured to focus on an amplitude or volume signature of the received utterance relative to the sample voice commands. A third one of the plurality of utterance processing modules can be configured to focus on the tone and/or pace of the received set of utterance data relative to a previous utterance as described above. A re-sealed or blended set of utterance data can be used to search the voice command options in database 170.

A fourth one of the plurality of utterance processing modules can be configured to focus on the specific characteristics of the particular speaker. In this case, the utterance processing module can access ancillary data, such as the identity and profile of the speaker. This information can be used to adjust speech recognition parameters to produce a speech recognition model that is more likely to match the speaker's utterances with a voice command in database 170. For example, the age, gender, and native language of the speaker can be used to tune the parameters of the speech recognition model to produce better results.

A fifth one of the plurality of utterance processing modules can be configured to focus on the context in which the utterance is spoken (e.g., the location of the vehicle, the specified destination, the time of day, the status of the vehicle, etc.). This utterance processing module can be configured to obtain ancillary data from a variety of sources described above, such as the vehicle operational subsystems 115, the in-vehicle GPS receiver 117, the in-vehicle web-enabled devices 118, and/or the user mobile devices 130. The information obtained from these sources can be used to adjust speech recognition parameters to produce a speech recognition model that is more likely to match the speaker's utterances with a voice command in database 170. For example, as described above, the utterance processing module can obtain ancillary data indicative of the current location of the vehicle as provided by a navigation subsystem or GPS device in the vehicle 119. The vehicle's current location is one factor that is indicative of the context of the utterance. Given the vehicle's current location, the utterance processing module may be better able to reconcile ambiguities in the received utterance. For example, an ambiguous utterance may be received by the voice command recognition and auto-correction module 200 as, “Navigate to 160 Maple Avenue.” In reality, the speaker may have wanted to convey, “Navigate to 116 Marble Avenue.” Using the vehicle's current location and a navigation or mapping subsystem, the utterance processing module can determine that there is no “160 Maple Avenue” in proximity to the vehicle's location or destination, but there is a “116 Marble Avenue” location. In this example, the utterance processing module can automatically match the ambiguous utterance to an appropriate voice command option. As such, an example embodiment can perform automatic correction of voice commands. In a similar manner, other utterance context ancillary data can be used to enhance the operation of the utterance processing module and the speech recognition process. Additionally, an example embodiment can perform automatic correction of voice commands using the utterance context ancillary data.

A sixth one of the plurality of utterance processing modules can be configured to focus on the context of the speaker (e.g., whether travelling for business or pleasure, whether there are events in the speaker's calendar or correspondence in their email or message queues, the status of processing of the speaker's previous utterances on other occasions, the status of processing, of other speaker's related utterances, the historical behavior of the speaker while processing the speaker's utterances, and a variety of other data obtainable from a variety of sources, local and remote. This utterance processing module can be configured to obtain ancillary data from a variety of sources described above, such as the in-vehicle web-enabled devices 118, the user mobile devices 130, and/or network resources 122 via network 120. The information obtained from these sources can be used to adjust speech recognition parameters to produce a speech recognition model that is more likely to match the speaker's utterances with a voice command in database 170. For example, the utterance processing module can access the speaker's mobile device 130, web-enabled device 118, or account at a network resource 122 to obtain speaker-specific context information that can be used to rectify ambiguous utterances in a manner similar to the process described above. This speaker-specific context information can include current events listed on the speaker's calendar, the content of the speaker's address book, a log of the speaker's previous voice commands and associated audio signatures, content of recent email messages or text messages, and the like. The utterance processing module can use this speaker-specific context ancillary data to enhance the operation of the utterance processing module and the speech recognition process. Additionally, an example embodiment can perform automatic correction of voice commands using the speaker-specific context ancillary data.

It will be apparent to those of ordinary skill in the art in view of the disclosure herein that a variety of other utterance processing modules can be configured to enhance the processing accuracy of the speech recognition processes described herein. As described above, the repeat utterance correlation logic module 212 can submit the received set of utterance data to each or any one of a plurality of utterance processing modules as described above to analyze the utterance data from a plurality of perspectives. Because of the deeper level of analysis and/or the different voice recognition process provided by the repeat utterance correlation logic module 212, a greater quantity of computing resources (e.g., processing cycles, memory storage, etc.) may need to be used to effect the speech recognition analysis. As such, it is not usually feasible to perform this deep level of analysis for every received utterance. However, the embodiments described herein can selectively employ this deeper level of analysis and/or a different voice recognition process only when it is required as described above. In this manner, a more robust and effective speech recognition analysis can be provided while preserving valuable computing resources.

As described above, the repeat utterance correlation logic module 212 can provide a deeper level of analysis and/or a different voice recognition process when the speech recognition logic module 210 produces poor results. Additionally, the repeat utterance correlation logic module 212 can recognize when a currently received utterance is a repeat of a prior utterance. Often, when an utterance is misunderstood, the user/speaker will repeat the same utterance and continue repeating the utterance until the system recognizes the voice command. In an example embodiment, the repeat utterance correlation logic module 212 can identify a current utterance as a repeat of a previous utterance using a variety of techniques. In one example, the repeat utterance correlation logic module 212 can compare the audio signature of a current utterance to the audio signature of a previous utterance. The repeat utterance correlation logic module 212 can also compare the tone and/or pace of a current utterance to the tone and pace of a previous utterance. The timing of a time gap between the current utterance and a previous utterance can also be used to infer that a current utterance is likely a repeat of a prior utterance. Using any of these techniques, the repeat utterance correlation logic module 212 can identify a current utterance as a repeat of a previous utterance. Once it is determined that a current utterance is a repeat of a prior utterance, the repeat utterance correlation logic module 212 can determine that the speaker is trying to be recognized for the same voice command and the prior speech recognition analysis is not working. In this case, the repeat utterance correlation logic module 212 can employ the deeper level of speech recognition analysis and/or as different voice recognition process as described above. In the manner, the repeat utterance correlation logic module 212 can be configured to match the set of utterance data to a voice command and return information indicative of the matching voice command without returning information that is the same as previously returned information if the set of utterance data is a repeat utterance.

An example embodiment can also record or log parameters associated with the speech recognition analysis performed on a particular utterance. These log parameters can be stored in log database 174 of database 170 as shown in FIG. 2. The log parameters can be used as a historical reference to retain information related to the manner in which an utterance was previously analyzed and the results produced by the analysis. This historical data can be used in the subsequent analysis of a same or similar utterance.

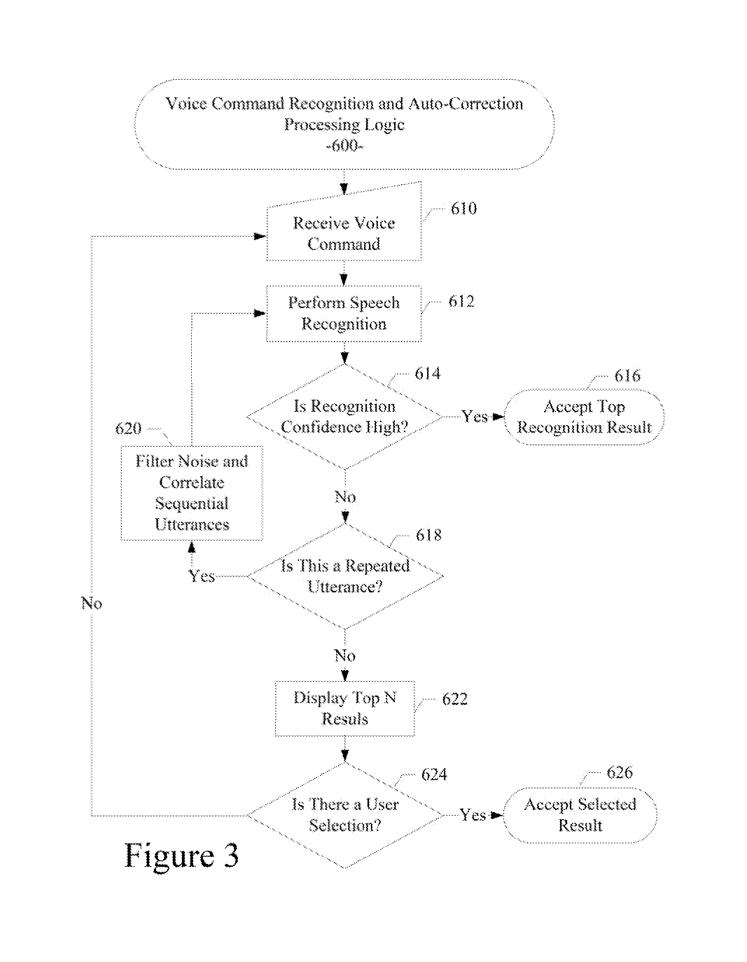

Referring now to FIG. 3, a flow diagram illustrates an example embodiment of a system and method 600 for recognition and automatic correction of voice commands. In processing block 610, the embodiment can receive a one or more sets of utterance data from the IVI system 150 via voice interface 158. In processing block 612, the speech recognition logic module 210 of an example embodiment as described above can be used to perform a first-level speech recognition analysis on the received set of utterance data to produce a first result. The speech recognition logic module 210 can also produce a confidence value associated with the first result, the confidence value corresponding to the likelihood that (or the degree to which) a particular received utterance matches a corresponding sample voice command. The speech recognition logic module 210 can also rank the search results based on the confidence value for a particular received utterance and a corresponding sample voice command. At decision block 614, if a matching voice command is found and the confidence value associated with the match is high, the high-confidence matching result can be returned and the processing performed by the voice command recognition and auto-correction module 200 can be terminated at bubble 616. At decision block 614, if a matching voice command is not found or the confidence value associated with the match is not high, processing continues at decision block 618.

At decision block 618, if the received set of utterance data is determined to be a repeat utterance as described above, processing continues at processing block 620 where a second-level speech recognition analysis is performed on the received set of utterance data using the repeat utterance correlation logic module 212 as described above. Once the second-level speech recognition analysis performed by the repeat utterance correlation logic module 212 is complete, processing can continue at processing block 612 where speech recognition analysis is again performed on the processed set of utterance data.

At decision block 618, if the received set of utterance data is determined to not be a repeat utterance as described above, processing continues at processing block 622 where the top n results produced by the speech recognition logic module 210 are presented to the user/speaker. As described above, these results can be ranked based on the corresponding confidence values for each matching result. Once the ranked results are presented to the user/speaker, the user/speaker can be prompted to select one of the presented result options. At decision block 624, if the user/speaker selects one of the presented result options, the selected result is accepted and processing terminates at bubble 626. However, if the user/speaker does not provide a valid result option selection within a pre-determined time limit, the process resets and processing continues at processing block 610 where a new set of utterance data is received.

As used herein and unless specified otherwise, the term “mobile device” includes any computing or communications device that can communicate with the IVI system 150 and/or the voice command recognition and auto-correction module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript, C++, iOS, Android, etc.

As used herein and unless specified otherwise, the term “network resource” includes any device, system, or service that can communicate with the IVI system 150 and/or the voice command recognition and auto-correction module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g. MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

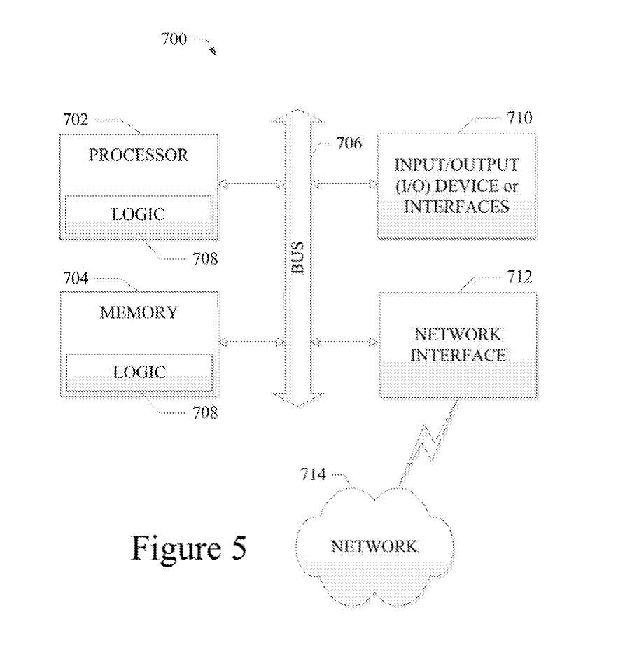

The network 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly. The network 120 may further employ one or more of a plurality of standard wireless and/or cellular protocols or access technologies including those set forth below in connection with network interface 712 and network 714 described in detail below in relation to FIG. 5.

In a particular embodiment, a mobile device 130 and/or a network resource 122 may act as a client device enabling a user to access and use the IVI system 150 and/or the voice command recognition and auto-correction module 200 to interact with one or more components of a vehicle subsystem. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), Internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The IVI system 150 and/or the voice command recognition and auto-correction module 200 can be implemented using systems that enhance the security of the execution environment, thereby improving security and reducing the possibility that the IVI system 150 and/or the voice command recognition and auto-correction module 200 and the related services could be compromised by viruses or malware. For example, the IVI system 150 and/or the voice command recognition and auto-correction module 200 can be implemented using a Trusted Execution Environment, which can ensure that sensitive data is stored, processed, and communicated in a secure way.

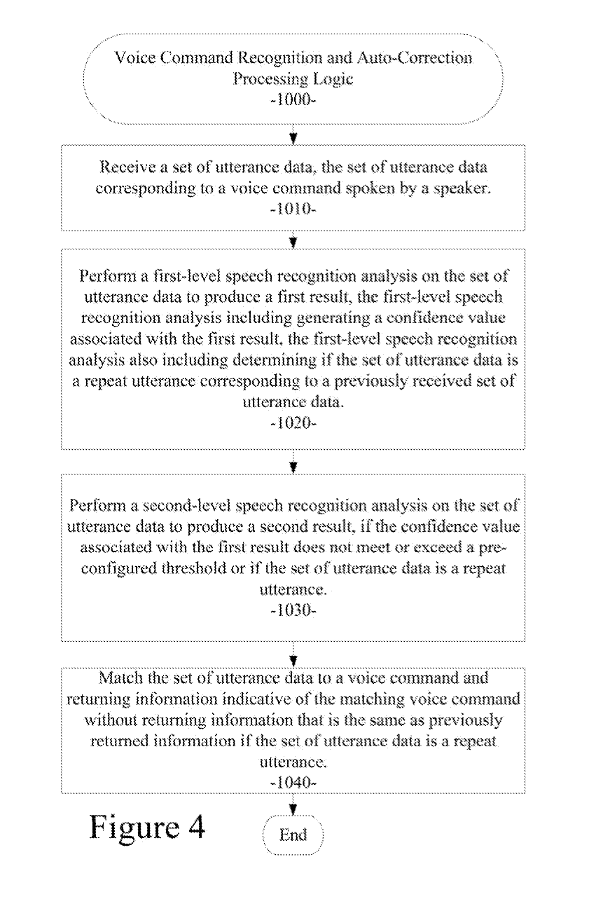

FIG. 4 is a processing flow diagram illustrating an example embodiment of the system and method for recognition and automatic correction of voice commands as described herein. The method 1000 of an example embodiment includes: receiving a set of utterance data, the set of utterance data corresponding to a voice command spoken by a speaker (processing block 1010); performing a first-level speech recognition analysis on the set of utterance data to produce a first result, the first-level speech recognition analysis including generating a confidence value associated with the first result, the first-level speech recognition analysis also including determining if the set of utterance data is a repeat utterance corresponding to a previously received set of utterance data (processing block 1020); performing a second-level speech recognition analysis on the set of utterance data to produce a second result, if the confidence value associated with the first result does not meet or exceed a pre-configured threshold or if the set of utterance data is a repeat utterance (processing block 1030); and matching the set of utterance data to a voice command and returning information indicative of the matching voice command without returning information that is the same as previously returned information if the set of utterance data is a repeat utterance (processing block 1040).

FIG. 5 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), to cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 can include a data processor 702 (e.g., a System-on-a-Chip (SoC), general processing core, graphics core, and optionally other processing logic) and a memory 704, which can communicate with each other via a bus or other data transfer system 706. The mobile computing, and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth®, IEEE 802.11x, and the like. In essence, network interface 712 may include or support virtually any wired and/or wireless communication and data processing mechanisms by which information/data may travel between a mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., as centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
receiving a set of utterance data, the set of utterance data corresponding to a voice command spoken by a speaker;
performing a first-level speech recognition analysis on the set of utterance data to produce a first result, the first-level speech recognition analysis including generating a confidence value associated with the first result, the first-level speech recognition analysis also including determining if the set of utterance data is a repeat utterance corresponding to as previously received set of utterance data;
performing a second-level speech recognition analysis on the set of utterance data to produce a second result, if the confidence value associated with the first result does not meet or exceed a pre-configured threshold or if the set of utterance data is a repeat utterance; and
matching the set of utterance data to a voice command and returning information indicative of the matching voice command without returning information that is the same as previously returned information if the set of utterance data is a repeat utterance.

2. The method as claimed in claim 1 wherein the set of utterance data is received via a vehicle subsystem of a vehicle, the vehicle subsystem comprising an electronic in-vehicle infotainment (IVI) system installed in the vehicle, or a mobile device proximately located in or near the vehicle.

3. The method as claimed in claim 1 wherein producing the first result includes performing a search of a database to attempt to match the received set of utterance data to any of a plurality of sample voice commands stored in the database.

4. The method as claimed in claim 3 wherein the sample voice commands stored in the database include a typical or acceptable audio signature corresponding to a particular valid system command with an associated command code or command identifier.

5. The method as claimed in claim 3 wherein the confidence value corresponding to a likelihood that the received set of utterance data matches a corresponding sample voice command of the plurality of sample voice commands.

6. The method as claimed in claim 3 wherein any of the plurality of sample voice commands stored in the database can be dynamically updated or modified from a local or remote source.

7. The method as claimed in claim 1 wherein the second-level speech recognition analysis comprises a deeper level or different process of voice recognition analysis relative to the first-level speech recognition analysis.

8. The method as claimed in claim 1 wherein the second-level speech recognition analysis includes submitting the received set of utterance data to each of a plurality of utterance processing modules to analyze the received set of utterance data from a plurality of perspectives.

9. The method as claimed in claim 8 wherein the plurality of utterance processing modules include at least one from the group consisting of: an utterance processing module configured to focus on specific characteristics of the particular speaker; an utterance processing module configured to focus on a context in which the received set of utterance data is spoken; and an utterance processing module configured to focus a context of the speaker.

10. The method as claimed in claim 1 further including using ancillary data obtained from a local or remote source to modify the operation of the first-level and the second-level speech recognition analysis.

11. The method as claimed in claim 1 further including presenting a plurality of result options to a user for selection if the confidence value associated with the first result does not meet or exceed a pre-configured threshold and the received set of utterance data is determined to not be a repeat utterance.

12. A system comprising:
a data processor;
a voice interface, in data communication with the data processor, to receive a set of utterance data; and
a voice command recognition and auto-correction module being configured to:
receive the set of utterance data via the voice interface, the set of utterance data corresponding to a voice command spoken by a speaker;
perform a first-level speech recognition analysis on the set of utterance data to produce a first result, the first-level speech recognition analysis being further configured to generate a confidence value associated with the first result, the first-level speech recognition analysis also including determining if the set of utterance data is a repeat utterance corresponding to a previously received set of utterance data;
perform a second-level speech recognition analysis on the set of utterance data to produce a second result, if the confidence value associated with the first result does not meet or exceed a pre-configured threshold or if the set of utterance data is a repeat utterance; and
match the set of utterance data to a voice command and return information indicative of the matching voice command without returning information that is the same as previously returned information if the set of utterance data is a repeat utterance.

13. The system as claimed in claim 12 wherein the voice interface is part of a vehicle subsystem comprising an electronic in-vehicle infotainment (IVI) system installed in a vehicle, or a mobile device proximately located in or near the vehicle.

14. The system as claimed in claim 12 being further configured to perform a search of a database to attempt to match the received set of utterance data to any of a plurality of sample voice commands stored in the database.

15. The system as claimed in claim 14 wherein the sample voice commands stored in the database include a typical or acceptable audio signature corresponding to a particular valid system command with an associated command code or command identifier.

16. The system as claimed in claim 14 wherein the confidence value corresponding to a likelihood that the received set of utterance data matches a corresponding sample voice command of the plurality of sample voice commands.

17. The system as claimed in claim 14 wherein any of the plurality of sample voice commands stored in the database can be dynamically updated or modified from a local or remote source.

18. The system as claimed in claim 12 wherein the second-level speech recognition analysis being further configured to submit the received set of utterance data to each of a plurality of utterance processing modules to analyze the received set of utterance data from a plurality of perspectives, the plurality of utterance processing modules including at least one from the group consisting of: an utterance processing module configured to focus on specific characteristics of the particular speaker; an utterance processing module configured to focus on a context in which the received set of utterance data is spoken; and an utterance processing module configured to focus a context of the speaker.

19. The system as claimed in claim 12 being further configured to use ancillary data obtained from a local or remote source to modify the operation of the first-level and the second-level speech recognition analysis.

20. The system as claimed in claim 12 being further configured to present a plurality of result options to a user for selection if the confidence value associated with the first result does not meet or exceed a pre-configured threshold and the received set of utterance data is determined to not be a repeat utterance.

21. A non-transitory machine-useable storage medium embodying instructions which, when executed by a machine, cause the machine to:
receive a set of utterance data, the set of utterance data corresponding to a voice command spoken by a speaker;
perform a first-level speech recognition analysis on the set of utterance data to produce a first result, the first-level speech recognition analysis being further configured to generate a confidence value associated with the first result, the first-level speech recognition analysis also including determining if the set of utterance data is a repeat utterance corresponding to a previously received set of utterance data;
perform a second-level speech recognition analysis on the set of utterance data to produce a second result, if the confidence value associated with the first result does not meet or exceed a pre-configured threshold or if the set of utterance data is a repeat utterance; and
match the set of utterance data to a voice command and return information indicative of the matching voice command without returning information that is the same as previously returned information if the set of utterance data is a repeat utterance.

22. The machine-useable storage medium as claimed in claim 21 wherein the set of utterance data is received via a vehicle subsystem of a vehicle, the vehicle subsystem comprising an electronic in-vehicle infotainment (IVI) system installed in the vehicle, or a mobile device proximately located in or near the vehicle.
